(19) United States
(12) Patent Application Publication
(10) Pub. No.: US 2006/0101465 A1
(43) Pub. Date: May 11, 2006

(54) Distributed control system

(75) Inventors: Naoki Kato, Kodaira (JP); Fumio Arakawa, Kodaira (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/068,782

(22) Filed: Mar. 2, 2005

(30) Foreign Application Priority Data
Nov. 9, 2004 (JP) 2004-324679

(51) Int. Cl. G06F 9/46

(52) U.S. Cl. 718/100

(57) ABSTRACT

In a distributed control system where a plurality of control units are connected via a network, the invention allows for efficient operation of each control unit, while ensuring real-time processing. To provide a distributed control system in which ensured real-time processing and enhanced fault tolerance are achieved, information of a deadline or task run cycle period as time required until task completion is given for each task and a control unit on which a task will be executed is selected according to the deadline or task cycle period. A first control circuit and related sensors and actuators are connected by a dedicated path on which fast response time is easy to ensure and another control circuit and related sensors and actuators are connected via a network. When the first control circuit operates normally with sufficient throughput, the first control circuit is used for control; in case the first control circuit fails or if its throughput is insufficient, another control circuit is used.

### CLAIM OF PRIORITY

The present application claims priority from Japanese application JP 2004-324679 filed on Nov. 9, 2004, the content of which is hereby incorporated by reference into this application.

### FIELD OF THE INVENTION

The present invention relates to a distributed control system where a plurality of control units which execute a program for controlling a plurality of devices to be controlled are connected via a network and, in particular, to a distributed control system for application strictly requiring real-time processing, especially typified by vehicle control.

### BACKGROUND OF THE INVENTION

In electronic control units (ECUs) for motor vehicles or the like, a control circuit (CPU) generates a control signal, based on information input from sensors and the like and outputs the control signal to actuators and the actuators operate, based on the control signal. Lately, such electronic control units have been used increasingly in motor vehicles. The control units are interconnected for communication for cooperative operation or data sharing and build a network.

In a distributed control system where a plurality of control units are connected via a network, each individual control unit is configured to execute a unit-specific control program and, thus, a control unit with processing performance adequate to handle a peak load is selected as a system component. However, the processing capacity of the control unit is not used fully in situations where the device to be controlled is inactive or does not require complicated control. Consequently, a problem in which the overall operating efficiency is low is presented.

Meanwhile, in computing systems that are used for business applications, academic researches, and the like, attempts have been made to enable vast amounts of processing power with enhanced speed by load sharing across a plurality of computers without requiring each computer to have a high performance. For example, in patent document 1 (Japanese Patent Laid-Open No. H9(1997)-167141), a method allowing for load sharing of multiple types of services across a plurality of computers constituting a computer cluster is proposed. For an in-vehicle distributed control system, a technique of load sharing across a plurality of control units is proposed. For example, patent document 2 (Japanese Patent Laid-Open No. H7(1995)-9887) discloses a system where control units are connected by a communication line to execute control of separate sections of a motor vehicle, wherein at least one control unit can execute at least one of control tasks of another control unit under a high load; this system is designed to enable a backup across the control units and for processing load averaging across them.

In patent document 3 (Japanese Patent Laid-Open No. 2004-38766), tasks to be executed by control units connected to a network, are divided into fixed tasks that must be executed on a particular control unit and floating tasks that can be executed on any control unit and a program for executing the floating tasks is managed at a manager control unit connected to the network. The manager control unit identifies a floating task to be executed dynamically in accordance with vehicle running conditions or instructions from the driver and assigns the floating task to a control unit that is put under a low load and can execute the floating task.

In general, a control circuit and related sensors and actuators are connected by a dedicated path. Patent document 4 (Japanese Patent Laid-Open No. H7(1995)-078004) discloses a method in which control circuits, sensors and actuators are all connected via network in the control unit, dispensing with dedicated paths. The advantage of this method is that control processing for an actuator, based on sensor information, can be executed by any control circuit connected to the network, not limited to a particular control circuit, by using the network instead of dedicated paths. As a result, even if a control circuit fails, another control circuit can back up easily; this improves reliability. Although not disclosed in the above publication, in this method combined with an appropriate distribute control technique, distributed processing of control across a plurality of control circuits is considered easier than in a system using dedicated paths.

As disclosed in the publication, network duplication just in case a network fault occurs is well known.

[Patent document 1] Japanese Patent Laid-Open No. H9(1997)-167141

[Patent document 2] Japanese Patent Laid-Open No. H7(1995)-9887

[Patent document 3] Japanese Patent Laid-Open No. 2004-38766

[Patent document 4] Japanese Patent Laid-Open No. H7(1995)-078004

### SUMMARY OF THE INVENTION

The technique disclosed in patent document 1 relates to a load sharing method in distributed computing environment mainly for business application and takes no consideration in respect of ensuring the performance of real-time processing of tasks. The technique disclosed in patent document 2 is a distributed control system for motor vehicle use wherein load sharing across a plurality of control units is performed, but takes no consideration in respect of ensuring the performance of real-time processing of tasks, which is especially important in vehicle control. In patent document 3, tasks are divided beforehand into tasks specific to each individual control unit and floating tasks that may be executed on any control unit and only the floating tasks that can be executed on any control unit can be processed by load sharing. In this case, it is needed to separate unit-specific tasks and floating tasks in advance when the system is built. In practical application, whether a task can be executed on another control unit changes, according to operating conditions. In vehicle control, generally, processing tasks to be processed by each individual control unit represent most of loads. If local tasks are not processed by load sharing, as suggested in patent document 3, few tasks remain to be processed by load sharing and, consequently, load sharing cannot be performed well.

In a distributed control system where a plurality of control units are connected via a network, a first challenge of the present invention is to provide a load sharing method allowing for efficient operation of each control unit, while ensuring the performance of real-time processing.

A second challenge to be solved by the present invention is to achieve enhanced fault tolerance, while ensuring the performance of real-time processing. For conventional typical electronic control units in which a control circuit and related sensors and actuators are connected by a dedicated path and an individual control program is run on each individual control unit, sufficient performance of real-time processing can be ensured, but, in case a control unit should fail, its operation stops. In short, these control units are low fault-tolerant. A conceivable solution is duplicating all control units, but system cost increase is inevitable.

Meanwhile, according to patent document 4, a similar system is configured such that information for all sensors and actuators are communicated via the network. In this case, even if a control unit fails, its related sensor information and actuator control signal can be communicated via the network and continuous operation can be maintained. However, it is required for electronic control units for motor vehicles or the like to process a task in a few milliseconds to a few tens of milliseconds from obtaining sensor information until actuator control signal output. Thus, the above network not only has sufficient throughput, also must ensure fast response time. However, in a situation where a great number of control circuits, sensors, and actuators send and receive information simultaneously, it is hard to ensure fast response time for all accesses.

Moreover, a third challenge is to virtualize a plurality of control circuits and facilitate a sharing process. In other words, this is to realize system uniformity in view from a user program, thus eliminating the need to program caring about a combination of a particular control circuit and a particular sensor or actuator, so that the system can be treated as if it was a single high-performance control circuit.

A fourth challenge of the present invention is to minimize the circuit redundancy and accomplish enhanced fault tolerance and a simple sharing process, applicable to cost-sensitive systems like motor vehicles.

To achieve the foregoing first challenge, the present invention provides a distributed control system where a plurality of control units connected via a network execute a plurality of tasks, and each control unit is arranged such that information of a deadline or task run cycle period as time required until task completion is given for each task and a control unit on which a task will be executed is selected according to the deadline or task cycle period. Each control unit is arranged such that time required to complete task processing and sending and return communication latency information if a task is executed on another control unit other than the control unit where the task was invoked to run are given for each task, thereby allowing for determining per task whether real-time processing can be ensured when the task is executed on another control unit connected via the network and selecting a control unit on which the task should be executed.

In consideration of that communication latency is determined by how much data to be transferred during a communication, the amount of data to be accessed for task execution within storage of each control unit and the amount of data to be accessed, corresponding to an input signal from an input device of each control unit are also given and each control unit is provided with means for calculating communication latency, based on the above amount of data. Moreover, each control unit is provided with means for observing network traffic and communication latency is modified by the traffic.

If the control units have different task processing throughputs such as their computing capacity and storage configuration, each control unit is provided with means for modifying task processing time according to task processing throughput. Furthermore, each control unit is provided with means for updating task processing time and communication latency information by past task run time statistics. A control unit stores tasks waiting for being executed in a task management list, refers to the task management list when a request to run a new task occurs, checks whether the new task can be completed within its deadline, if execution within the deadline is impossible, selects at least one task that should be requested of and executed by another control unit from among the tasks listed in the task management list and the new task to run, and sends a request command to run the selected task to another control unit via the network.

When sending the request command, the control unit sends the task's deadline and processing time information together. One means for determining another control unit to which task execution is requested, before sending the request command to run the task, sends the task's deadline processing time, and communication latency information to at least one of other control units, thereby inquiring whether the task can be completed within the deadline, and selects a control unit to which to send the request command to run the task actually from among other control units from which it received an acceptance return.

Another means for determining another control unit to which task execution is requested, before sending the request command to run the task, inquires of at least one of other control units about load status until the task's deadline time, checks whether the task can be completed by another control unit within the deadline from the task's deadline, processing time, and communication latency information and the load status returned, and selects a control unit to which to send the request command to run the task actually from among other control units on which the task can be executed as the result of the check.

A construction means for solving the second challenge connects a first control circuit and related sensors and actuators by a dedicated path on which fast response time is easy to ensure and connects another control circuit and related sensors and actuators via a network. When the first control circuit operates normally with sufficient throughput, the first control circuit is used for control; in case the first control circuit fails or if its throughput is insufficient, another control circuit is used.

Furthermore, the third challenge is solved such that task sharing is implemented by OS or middleware and a user program does not care that a particular task is executed exclusively by a particular control unit, and profit can be taken from the sharing process with simple user programming.

Furthermore, by provision of two paths, the dedicated path and network, the system is constructed such that, in case one control circuit fails, another control circuit can back up, without network duplication. Thus, duplication of each control circuit can be dispensed with, circuit redundancy can be suppressed, and the fourth challenge is solved.

### BRIEF DESCRIPTION OF THE DRAWINGS

FIG. 1 shows a system schematic diagram where N control units ECU1 to ECUN are connected to a network NW1.

FIGS. 2A to 2D show variations of schedules of tasks to be processed by the control circuit in Embodiment 1 with time relative to the present time taken as 0 on the abscissa.

FIG. 3 shows a task management list provided to explain another embodiment of load sharing in order that each control unit processes tasks in a deadline-compliant schedule.

FIG. 4 shows a control unit schematic diagram where task processing time PL registered in a task management list TL on each control unit is updated by past statistical data.

FIG. 5 shows a control unit schematic diagram where communication latency CL registered in the task management list TL on each control unit is updated by past statistical data.

FIG. 6 shows a control unit schematic diagram where communication latency registered in the task management list TL on each control unit is updated from the amount of data to be accessed for task execution and time to wait for communication.

FIG. 7 shows scheduled tasks to be processed by the control circuit on ECU2 in Embodiment 6 with time relative to the present time taken as 0 on the abscissa.

FIG. 8 shows a packet format to explain an example of a communication packet that is used for one control unit ECU to request another ECU to execute a task.

FIG. 9 is a flowchart to explain a flow example comprising a series of steps for task execution by load sharing after the occurrence of a request to run a task.

FIG. 10 is a flowchart to explain another flow example comprising a series of steps for task execution by load sharing after the occurrence of a request to run a task.

FIG. 11 shows a control system configuration employing both direct signal lines and a network.

FIG. 12 shows an example of a modification to the system configuration of FIG. 11 including duplicated networks.

FIG. 13 shows an example of a modification to Embodiment 10 wherein the system network in FIG. 11 is separated.

FIG. 14 shows an embodiment wherein the system network in FIG. 11 is separated in a different manner from the networks in FIG. 13.

FIG. 15 shows an embodiment wherein the network connections in the system of FIG. 11 are reduced.

FIG. 16 shows an embodiment wherein the system network in FIG. 15 is duplicated.

FIG. 17 shows an example of a modification to the system configuration of FIG. 11 where in a storage unit MEMU is connected to the network.

FIG. 18 shows a wireless network configuration example.

FIG. 19 shows an example of a network comprising control units connected via an in-vehicle LAN and a server external to the vehicle, the server being wirelessly connected to the LAN.

### DESCRIPTION OF THE PREFERRED EMBODIMENT

### Embodiment 1

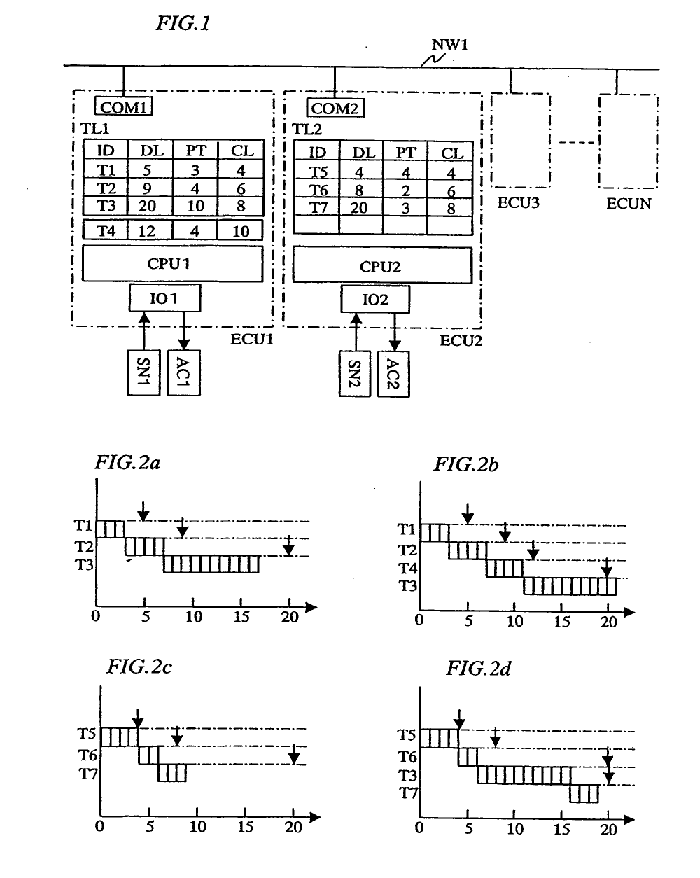

Embodiment 1 of the present invention is described with FIGS. 1 and 2. FIG. 1 shows a system schematic diagram where N control units ECU1 to ECUN are connected to a network NW1. However, control units ECU1 to ECU3 only are shown in FIG. 1; other control units are omitted. Internal structures of control units ECU1 and ECU 2 only are shown, as they are necessary for explanation. A control unit ECU1 is internally comprised of a communication device COM1 which is responsible for data communication, connecting to the network NW1, a control circuit CPU1 which processes tasks, and an input-output control circuit IO1 which sends and receives signals to/from a suite of sensors SN1 and a suite of actuators AC1. A task management list TL1 is also shown. The task management list TL1 is a list for managing tasks requested to run and waiting for being executed. This list is stored on a storage area and under the management of, e.g., an operating system run. The control units ECUs are so-called computers and it goes therefore without saying that they are equipped with necessities for fulfilling the functions as the computers. The ECU2 and other control units have the same internal structures as above.

The task management list TL for Embodiment 1 is a table of information including, at least, task ID, deadline DL, processing time PT, and communication latency CL, which are managed for the tasks to be executed by the control unit. Other information not relevant to the following explanation is omitted herein. The deadline DL is time by which the task must be completed by request. Because most tasks are iterative in a cycle, the period of the cycle of a task may be treated as the deadline for the task.

Likewise, a control unit ECU2 is internally comprised of a communication device COM2 which is responsible for data communication, connecting to the network NW1, a control circuit CPU2 which processes tasks, and an input-output control circuit IO2 which sends and receives signals to/from a suite of sensors SN2 and a suite of actuators AC2, and has a task management list TL2 on a storage area.

Assume that a request to run a task T4 has now occurred when three tasks, T1, T2, and T3 waiting for being executed have been set and managed in the task management list TL1 on the control unit ECU1. In the task management list TL1, the deadline DL, processing time PT, and communication latency CL are expressed in units of a certain period of time; for example, a time of 100 clocks of the control circuit CPU1 can be used as one unit of time. The deadline DL is usually expressed by time allowed to pass until the deadline after the task was requested to run; however, in Embodiment 1, all deadline values are expressed in terms of the remaining time until the deadline after the present time taken as 0 in an easy-to-understand manner.

FIGS. 2A to 2D show variations of schedules of tasks to be processed by the control circuit in Embodiment 1 with time relative to the present time taken as 0 on the abscissa. FIG. 2A shows scheduled runs of tasks T1, T2, and T3 on the control unit ECU1 before the occurrence of a request to run a task T4. One of successive rectangular boxes which represent a scheduled task run corresponds to one unit of time. Here, that is, it is indicated that the task T1 processing is completed in three units of time, the task T2 processing in four units of time, and the task T3 processing in ten units of time, and that the tasks are executed in order of T1, T2, and T3. A downward arrow marked at the upper edge of the line of the processing time of each task denotes the deadline of the task. Termination of the successive rectangular boxes of the task run at the left hand of the arrow indicates that the task can be executed in compliance with the deadline. In the situation of FIG. 2A, all the three tasks can be executed within their deadlines. Although several publicly-known methods may be used to determine the order in which tasks are executed, an Earliest Deadline First (EDF) method in which tasks are executed in order of earliest deadline is used for scheduling in this embodiment.

While some method allows for preemption, that is, suspending the on-going task to execute another task, non-preemptive scheduling in which no suspension of the on-going task takes place is assumed to be applied in Embodiment 1; however, the present invention is not limited to the non-preemptive scheduling.

Then, under the above situation, a request to run a new task T4 occurs at the control unit ECU1 and, consequently, the tasks including the task T4 are scheduled by the EDF method. FIG. 2B shows the thus scheduled task runs on the ECU1. Because the deadline of the task T4 is earlier than the deadline of the task T3, this scheduling is performed so that the task T4 will be executed before the task T3. In consequence, the tasks T1, T2, and T4 will be processed and completed within their deadlines, but the task T3 cannot meet the deadline time that comes at 20 units of time after.

Meanwhile, FIG. 2C shows scheduled task runs on another control unit ECU2 at this time. The tasks T5, T6, and T7 to be executed on the control unit ECU2 have sufficient time allowance. Thus, consider about having the newly occurred task T4 executed on the control unit ECU2. Since four units of time are required for processing the task T4, it is sufficient time allowance for the control unit ECU2 to execute the task T4 only in terms of the processing time. However, as is seen from reference to the task management list TL1 in FIG. 1, 10 units of time are taken as the latency of communication for sending a request to execute the task T4 via the network to the ECU2 and receiving the result of the execution. That is, the sum of the processing time PT and the communication latency CL is 14 units of time and this is over 12 units of time at which the deadline DL of the task T4 comes. Therefore, having the task T4 executed on the control unit ECU 2 cannot meet the deadline.

By checking the remaining tasks as to whether the task can be executed on another control unit in this manner, it turns out that only the task T3 can be done. FIG. 2D shows scheduled task runs on the control unit ECU2, wherein the task T3 is to be executed on the control unit ECU2. After the tasks T5 and T6 are executed on the control unit ECU2, the T3 is executed, followed by the T7 execution; in this schedule, all the tasks can be executed in compliance with their deadlines. That is, because there is time allowance of four units of time after the task T3 completion at the control unit ECU2, the deadline of the task T3 can be complied with, even if the result of the execution of the task T3 is transferred to the control unit ECU1, consuming four units of time, and used for control of the actuator AC1 operation. At this time, the control unit ECU1 is to execute the tasks T1, T2, and T4. Therefore, upon the request to run the task T4 occurred on the control unit ECU1, the control unit ECU1 sends a request to run the task T3 on the control unit ECU2 as a network command from it to the control unit ECU2 in order that the task T3 is processed on the control unit ECU2. In Embodiment 1, the communication latency is regarded as the sum of sending latency and return latency. Although the sending latency and the return latency differ in practical operation, both are assumed to be equal to simplify the explanation. As the result of the above task scheduling, all tasks on the control unit ECU1 and control unit ECU 2 comply with their deadline and task load sharing with ensured performance of real-time task processing can be implemented.

### Embodiment 2

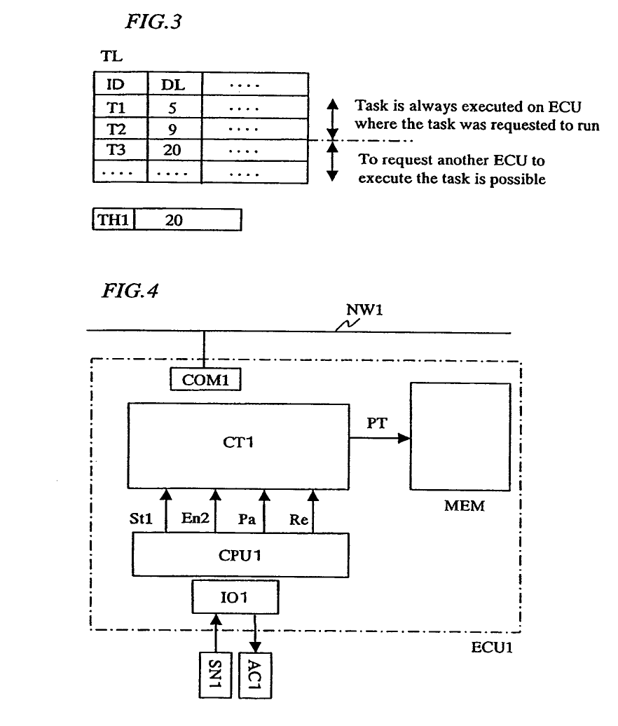

FIG. 3 shows a task management list provided to explain another embodiment of load sharing in order that each control unit processes tasks in a deadline-compliant schedule. Embodiment 2 uses the deadline only in determining a task that should be requested of and processed by another control unit. As compared with Embodiment 1, such decision is made in a simple way in this example of load sharing. In the task management list TL on each control unit, necessary information per task ID is managed in the same manner as described for FIG. 1. However, in this embodiment, it is sufficient to manage only the deadline DL information for each task and, thus, the list shown in FIG. 3 includes the deadline DL values sorted in ascending order. Besides, a threshold time TH1 of deadline DL is set separately. The threshold time is stored in a storage area of a memory, register, and the like.

In Embodiment 2, each control unit executes a task whose deadline is less than the threshold time TH1 on the control unit where the task was requested to run. For a task whose deadline DL is equal to or more than the threshold time TH1, it is possible to send a request to execute the task to any other control unit than the control unit where the task was requested to run. That is, a task with a smaller deadline DL will be executed unconditionally on the control unit where the task was requested to run. For a task with a greater deadline DL, a request to execute the task will be sent to any other control unit than the control unit where the task was requested to run, if it is determined that its deadline DL cannot be met. In this way, according to the list example of FIG. 3, the task 1 and task 2 are always executed on the control unit where they ware requested to run and the task 3 and subsequent tasks are allowed to be executed on another control unit and load sharing thereof can be applied. Although the communication latency and task processing time differ among individual tasks, load sharing in a deadline-compliant schedule can be carried out by setting the threshold time at a maximum value as the sum of communication latency and task processing time, for example.

In practical operation, it may be determined that a task requested to be executed on another control unit is impossible to be executed on that unit. However, the advantage of this embodiment resides in a simple structure and a small overhead in determining a task that should be requested of and executed by another control unit.

The communication latency CL and task processing time PT may change with network loads and control circuit configuration and usage or because of inconstant execution flows and may be difficult to estimate exactly. In such cases, the threshold time TH1 may be set including some degree of margin; therefore, Embodiment 2 is easy to implement. The threshold time TH can be preset and used as the fixed threshold or allowed to dynamically change. For example, with the provision of means for observing communication traffic, when the communication latency increases with a large network load, the threshold time can be reset longer; conversely, when the communication latency decreases, the threshold time can be reset shorter.

### Embodiment 3

FIG. 4 shows a control unit schematic diagram where task processing time PL registered in the task management list TL on each control unit is updated by past statistical data. The task processing time PT can be considered from a perspective as follows: a task execution flow is predicted and the processing time corresponds to the number of cycles of executive instructions to execute the flow. However, as mentioned in the description of Embodiment 2, the task processing time is difficult to estimate exactly, because it changes, according to circumstances. Thus, in Embodiment 3, means for measuring task processing time CT1 is provided to measure time in which a task is completed. According to actual measurements, the processing time value is updated.

When a task start indicating signal St1 is input to the means for measuring task processing time CT1, an internal counter (not shown) of the means for measuring task processing time CT1 starts to count. When a task end indicating signal En1 is input to the above means, the counter stops. When a task is suspended by an interrupt or the like, a pause signal Pa and restart signal Re are input to halt the counter temporarily. The above means measures the number of net cycles consumed for the task execution as the task processing time PT, updates the task processing time PT registered in the task management list TL, and stores it into a storage area MEM. Thereby, the maximum processing time and an average processing time from the past statistics can be used as task information.

### Embodiment 4

FIG. 5 shows a control unit schematic diagram where communication latency CL registered in the task management list TL on each control unit is updated by past statistical data. The communication latency can be estimated statistically from the amount of data transferred or the like, but may be difficult to estimate exactly because it changes, according to communication traffic congestion conditions, as mentioned in the description of Embodiment 2.

Thus, in Embodiment 4, means for measuring communication latency CT2 is provided to measure time from the input of a communication command until receiving the result, that is, from sending a request to execute a task through the communication device COM1 to another control unit until receiving the returned result of the task execution. When a signal St2 indicating the input of a communication command is input to the means for measuring communication latency CT2, an internal counter of the means for measuring communication latency CT2 starts to count. When a signal En2 indicating the reception of the returned result is input to the above means, the counter stops. Thereby, the above means measures the number of net cycles consumed for the task execution on another control unit through communication, obtains the communication latency CL by subtracting the task processing time from the thus measured time, updates the communication latency CL registered in the task management list TL, and stores it into a memory area MEM. Thereby, the maximum communication latency and average communication latency from the past statistics can be used as task information.

### Embodiment 5

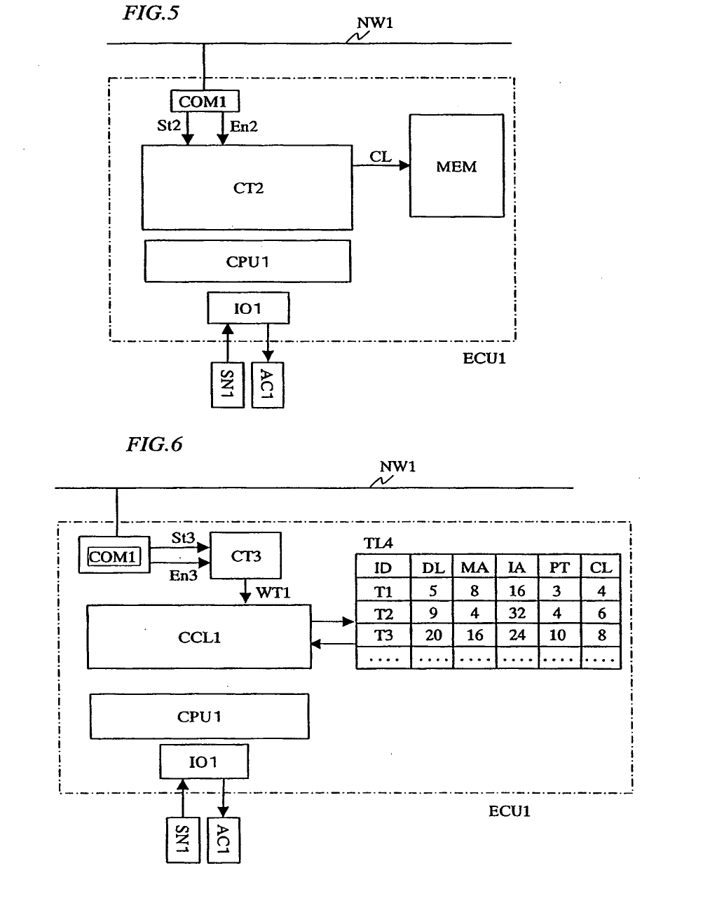

FIG. 6 shows a control unit schematic diagram where communication latency registered in the task management list TL on each control unit is updated from the amount of data to be accessed for task execution and time to wait for communication. When a communication request command is input by the communication device COM1, communication does not always begin promptly and may be deferred in some situations where the network path is occupied by another communication packet or a request to transmit a higher priority packet is queued. Usually, there is some wait time before the start of communication in accordance with the communication request command.

In Embodiment 5, the task management list TL is provided with information regarding the amount of memory data to be accessed MA and the amount of input data IA through an input device in addition to the data mentioned in FIG. 1. Here, the amount of memory data to be accessed MA and the amount of input data IA are expressed in terms of size of data to be handled, whereas other data is expressed in units of time. For example, referring to task T1, 8 bytes as the amount of memory data to be accessed MA and 16 bits as the amount of input data IA are accessed and used for processing the task.

Means for measuring time to wait for communication CT3 starts its internal counter upon the input thereto of a signal St3 indicating the input of a communication request command from the communication device COM1 and stops the counter when a signal En3 indicating the start of the communication is input to it. The above means inputs the thus obtained time to wait for communication WT1 to means for calculating communication latency CCL1. At this input, the means for calculating communication latency CCL1 obtains the amount of data to be transferred by the request to run the task from the amount of memory data to be accessed MA and the amount of input data IA and calculates the time required to transfer this data amount. By adding the time to wait for communication WT1 to the thus calculated time, the means for calculating communication latency CCL1 calculates the communication latency and fills the communication latency CL field with this new value in the task management list TL4.

The time to wait for communication WT1 can be measured at all times or may be measured periodically. Thereby, the communication latency reflecting the time to wait for communication and the amount of data to be transferred can be used. While communication latency calculation is executed, taking account of both the amount of data to be accessed and the time to wait for communication in Embodiment 5, it may be preferable to apply only either of the above, if the either is significantly governing.

### Embodiment 6

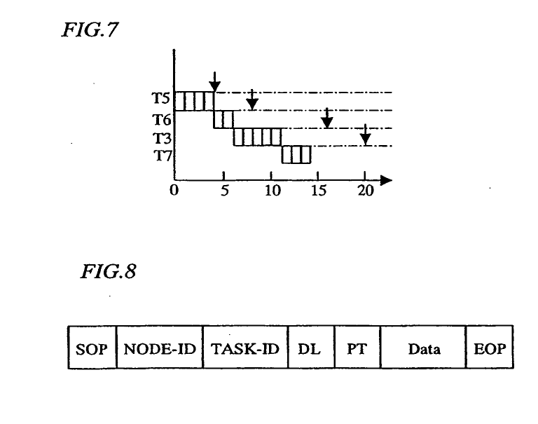

Next, an embodiment where the control units have different throughputs is discussed. Given that the control unit ECU2 operates at an operating frequency twice as high as the operating frequency of the control unit ECU1 in the situation of Embodiment 1, FIG. 7 shows scheduled tasks to be processed by the control circuit on the ECU2 in Embodiment 6 with time relative to the present time taken as 0 on the abscissa.

In the case of Embodiment 6, the processing time of a task on the control unit ECU1 is reduced by half when the task is processed on the control unit ECU2. For example, when the control unit ECU1 that is the task requester determines to request the control unit ECU2 to execute the task, it may inform the control unit ECU2 that the task T3 will be processed in five units of time, which is half cut, according to the throughput ratio between the requested control unit and itself. Alternatively, the control unit ECU1 may inform the requested control unit ECU2 that the task is processed in ten units of time as is and the control unit ECU2 may regard the processing time for the task as half-cut five units of time, according to the throughput ratio between the requesting control unit and itself. In either case, the result is that the task T3 is processed in five units of time on the control unit ECU2, as scheduled in FIG. 7.

FIG. 8 shows a packet format to explain an example of a communication packet that is used for one control unit ECU to request another ECU to execute a task. The communication packet is comprised of SOP denoting the start of the packet, NODE-ID which identifies the source node, namely, the control unit from which the packet is transmitted, TASK-ID which identifies the task requested to execute, the task deadline DL, processing time PT, data necessary for execution, and EOP denoting the end of the packet. The deadline DL may be expressed in absolute time notation common to the requesting control unit and the requested control unit or relative time notation relative to the time at which the packet arrives at the requester control unit. As described above, the deadline is changed by subtracting the time required for return from it. Because data amount varies among tasks, while the packet length is fixed, some data may not be transmitted in a single packet. In this case, the data can be transmitted with multiple packets in which a flag to indicate data continuation is inserted except the last one.

### Embodiment 7

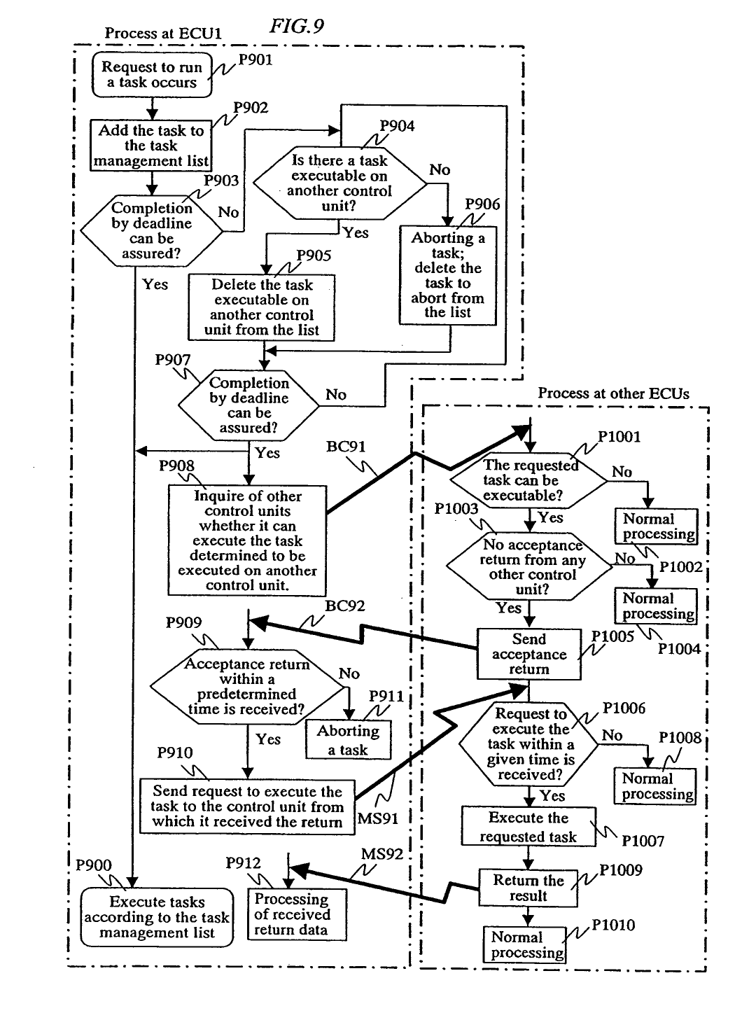

FIG. 9 is a flowchart to explain a flow example comprising a series of steps for task execution by load sharing after the occurrence of a request to run a task. FIG. 9 illustrates a process (steps P900 to P912) at the control unit ECU1 where a request to run a new task has occurred and a process (steps P1001 to P1009) at other control units in relation to the above process. Communications (BC91, BC92, MS91, MS92) between the control units are denoted by bold arrows.

When a request to run a task occurs (step P901) at the control unit ECU1, the ECU1 adds the new task to the task management list (step P902) and determines whether all tasks can be completed in compliance with their deadlines (step P903). If the tasks can be done, the ECU1 executes the tasks according to the task management list (step P900). If not, as determined at step P903, the ECU1 checks the tasks managed in the task management list as to whether there is a task that should be requested of and executed by another control unit ECU (step P904). Here, a task that can be executed on another control unit is selected in view of task processing time and communication latency as well as task deadline, as described in, e.g., Embodiment 1 and Embodiment 2. The selected task is deleted from the management list (step P905). If there is no task that can be executed on another control unit ECU, the ECU1 aborts a task (step P906). Aborting a task is done, for example, in such away that a task of lowest importance, according to predetermined task priorities, is deleted from the management list. In aborting a task, the task to abort is deleted from the management list.

Next, the ECU1 determines whether all the remaining tasks in the updated management list can be completed in compliance with their deadlines (step P907). If not, returning to step P904, the ECU1 again selects a task that should be requested of and executed by another control unit ECU; this step is repeated until it is determined that the tasks can be done at step P907. If “Yes” as determined at step P907, the ECU1 executes the tasks according to the task management list (step P900) and performs the following steps for the task selected as the one that should be requested of and executed by another control unit ECU.

The ECU1 inquires of other control units ECUs whether the control unit can execute the task within its deadline (step P908). This inquiry may be sent by either of the following two optional ways: sending an inquiry message to each of other control units ECUs one by one in predetermined order; and sending broadcast messages of inquiry to all other control units at a time. In Embodiment 7, the inquiry is broadcasted to other control units ECUs by a broadcast BC 91 denoted by a bold arrow in FIG. 9. The inquiry may be transmitted in the packet illustrated in FIG. 8, for example. However, because data transmission is not necessary at the inquiry stage, it is preferable to transmit information in the packet structure of FIG. 8 from which the data part is removed.

Having received this inquiry, a control unit ECU determines whether it can execute the requested task within its deadline, referring to the deadline and processing time information and its own task management list (step P1001). If the ECU cannot execute the task, it sends back nothing and returns to its normal processing (step P1002). If the ECU can execute the task, as determined at step P1001, it returns a message that it can do. However, because the inquiry was broadcasted to all other control units ECUs in Embodiment 7, if a plurality of control units ECUs can execute the task at the same time, there is a probability of a plurality of returns being sent from the ECUs at the same time. Here, by way of example, this problem is addressed by using a Control Area Network (commonly known as CAN), which is explained below. In the CAN protocol, a communication path is allocated in accordance with node priorities so that simultaneous transmissions do not collide with each other. When a low-priority node detects a transmission from another higher-priority node, it suspends its transmission and waits until the communication path can be allocated to it. Then, the ECU determines whether an acceptance return message from another control unit occurs (step P1003). If an acceptance return message from another control unit ECU occurs, the ECU receives it and returns to its normal processing (step P1004). Only if the ECU does not receive such message, it sends an acceptance broadcast BC92 to all other control units ECUs (step P1005). When the control unit ECU waits for the release of the communication path to send the acceptance return, if receiving an acceptance broadcast BC92 sent from another control unit ECU, it quits waiting for communication and returns to its normal processing (steps P1003, P1004).

After sending the acceptance return, the ECU determines whether it has received a request to execute the task within a given time (step P1006). When having received the request to execute the task, the ECU executes the task (step P1007); if not, it returns to its normal processing (step P1008). After executing the requested task, the ECU sends a message MS92 having the result of the execution to the control unit ECU1 (step P1009) and returns to its normal processing (step P1010).

The control unit ECU1 determines whether it has received an acceptance broadcast BC92 within a predetermined time (step P909). When having received the broadcast BC92 within the predetermined time, the ECU1 sends a request message MS91 to execute the task to the control unit from which it received the acceptance return (step P910). When receiving a return message MS 92 having the result data from the requested ECU, the ECU1 performs processing of the return data such as storing the data into the memory or using the data as an output signal for actuator control (step P912). Otherwise, when the ECU1 has not received the broadcast BC92 within the predetermined time, the ECU1 aborts a task (step P911).

Included in the process at the control unit ECU1, a series of steps, inquiring of other control units ECUs whether it can execute the task (step 908), determining whether it has received a return (step P909), sending a request to execute the task (step P911), aborting a task (step P911), and processing of return data (step P912) are performed for all tasks selected as those that should be requested of and executed by another control unit ECU.

### Embodiment 8

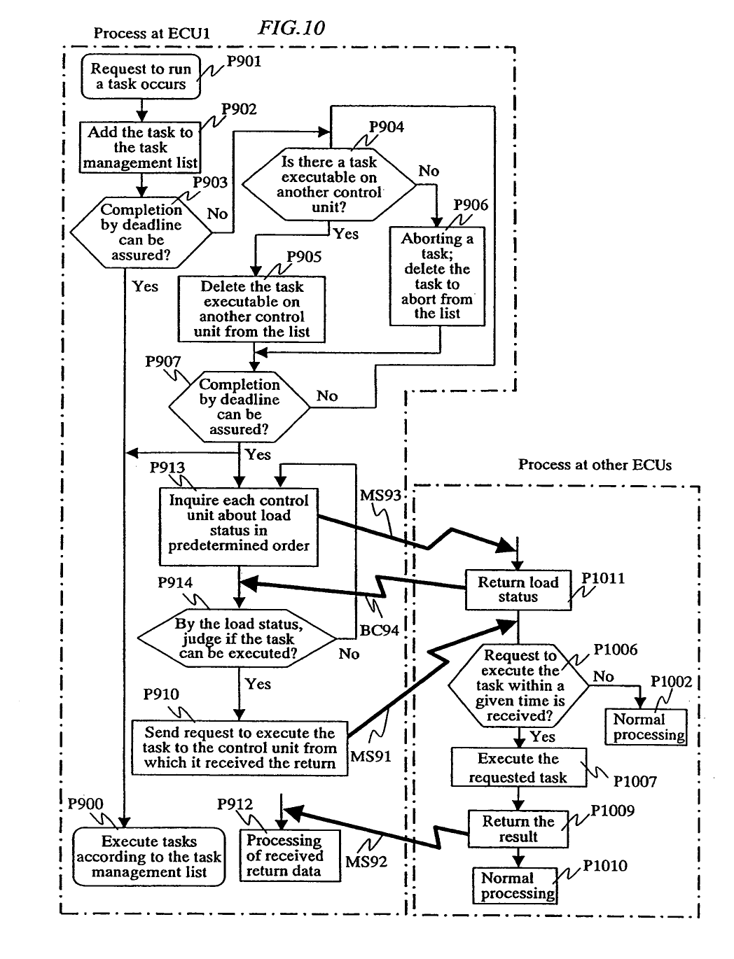

FIG. 10 is a flowchart to explain another flow example comprising a series of steps for task execution by load sharing after the occurrence of a request to run a task. As is the case for Embodiment 7, in Embodiment 8 also, the ECU1 determines whether all the remaining tasks in the updated management list can be completed in compliance with their deadlines (step P907). If not, returning to step P904, the ECU1 again selects a task that should be requested of and executed by another control unit ECU: this step is repeated until it is determined that the tasks can be done at step P907. If “Yes” as determined at step P907, the ECU1 executes the tasks according to the task management list (step P900) and performs the following steps for the task selected as the one that should be requested of and executed by another control unit ECU.

While the inquiry of other ECUs whether it can execute the task within its deadline is broadcasted to the ECUs in Embodiment 7, a message MS93 inquiring each control unit ECU about load status during the time until the deadline of the requested task is sent to each individual ECU (step 913) in Embodiment 8; in this respect, there is a difference from Embodiment 7. For example, this message inquires of each control unit ECU about idle time until a certain point of time. Referring to the example of FIG. 1, the message inquires of each ECU about load status until 16 units of time determined by subtracting a return latency time from the deadline of task T3. In response to this inquiry, the inquired control unit ECU returns its load status by a broadcast BC94 (step P1011). Again referring to the example of FIG. 1, the control unit ECU 2 returns a message that it has allowance of 10 units of idle time as task T7 is scheduled to start at 17 units of time. Having received the return, the control unit ECU1 determines whether the task can be executed on the inquired control unit ECU (step P914). In the example of FIG. 10, the ECU1 inquires of other control units in predetermined order and repeats the inquiry until it has found a control unit ECU on which the task can be executed. It is practically reasonable that a limit number of control units to be inquired is preset, the function of which is not shown to avoid complication, and the inquiry should be repeated up to the limit number or until all control units ECU have been inquired; nevertheless, if a control unit ECU on which the task can be executed is not found, aborting a task is performed. When a control unit ECU on which the task can be executed is found from the load status response, the ECU1 sends a request to execute the task to the control unit ECU from which it received the return (step P910). The following steps in which the requested control unit ECU processes the task requested and returns the result of the task execution to the control unit ECU1 are the same as in Embodiment 7.

Alternatively, it is possible to attach a storage unit accessible for all control units ECUs to the network NW1 and set up a database in which each control unit will store their load status periodically at predetermined intervals. If such database is available, the control unit ECU1 can access the database and obtain information by which it can determine what ECU to which task processing can be requested. Consequently, it will become unnecessary to inquire of other control units ECUs whether it can execute the task, as involved in Embodiment 7, and inquired of other control units ECUs about their load status, as involved in Embodiment 8.

This embodiment and Embodiment 7 illustrate an instance where, whether all tasks to be processed can be completed in compliance with their deadline is determined; if not as determined, a task is selected to be executed on another control unit. Not only for the case of deadline noncompliance, the present invention is also carried out for the purpose of load leveling across the control units. In the flowcharts of FIGS. 9 and 10 to explain Embodiments 7 and 8, respectively, for example, the step of determining whether all tasks can be completed in compliance with their deadline (step P903 and step P907) can be replaced with the step of calculating a CPU load factor if all tasks are executed and the step of determining whether the load factor exceeds a predetermined load factor, e.g., 70%. Thereby, the load sharing method of this invention can be carried out for load leveling. Leveling the CPU loads is capping the load factor for the CPUs of the control units, in other words, the system can be realized with the CPUs with lower performance than ever before and the cost of the system can be reduced.

### Embodiment 9

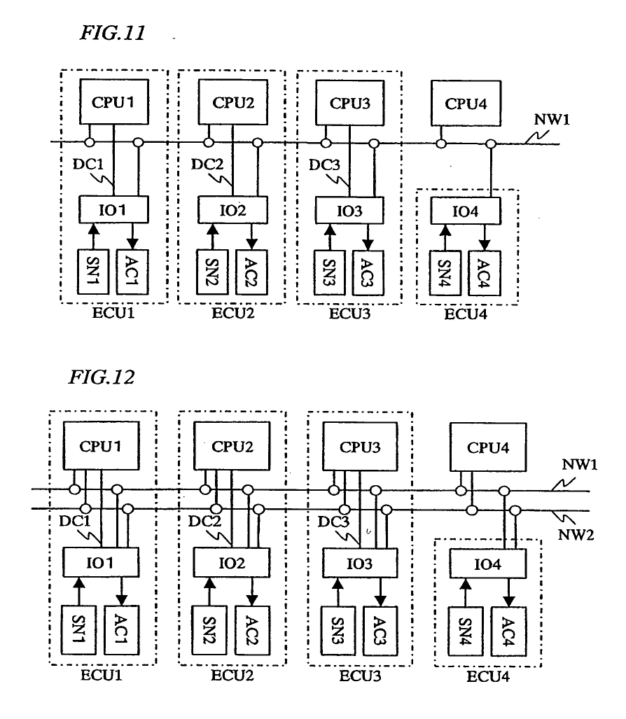

FIG. 11 shows a control system configuration employing both direct signal lines and a network. An electronic control unit ECU1 is comprised of a control circuit CPU1, an input-output control circuit IO1, a suite of sensors SN1, and a suite of actuators AC1. Senor information is input from the suite of sensors SN1 to the input-output control circuit IO1 and actuator control information is output from the input-output control circuit IO1 to the suite of actuators AC1. The control circuit CPU1 and the input-output control circuit IO1 are connected by a direct signal line DC1. Besides, both the control circuit CPU1 and the input-output control circuit IO1 are connected to the network NW1. Electronic control units ECU2 and ECU3 also have the same configuration as above.

An electronic control unit ECU4 is comprised of an input-output control circuit IO4, a suite of sensors SN4, and a suite of actuators AC4. Senor information is input from the suite of sensors SN4 to the input-output control circuit IO4 and actuator control information is output from the input-output control circuit IO4 to the suite of actuators AC4. Besides, the input-output control circuit IO4 is connected to the network NW1. The electronic control unit ECU4 in Embodiment 9 does not have a control circuit independent of the sensor suite and the actuator suite, unlike other electronic control units ECU1, ECU2, and ECU3.

A control circuit CPU4 is an independent control circuit that is not connected by a direct signal line to any input-output control circuit connected to the network NW1.

Then, typical operation of Embodiment 9 is described. A process of generating actuator control information based on sensor information will be referred to as a control task. Generally, there are a great number of tasks to which the sensor suite SN1 and the actuator suite AC1 relate. In the electronic control unit ECU1, normally, the input-output control circuit IO1 sends sensor information received from the sensor suite SN1 to the control circuit CPU1 via the direct signal line DC1. The control circuit CPU1 executes a control task, based on the received sensor information, and sends generated actuator control information to the input-output control circuit IO1 via the direct signal line DC1. The input-output control circuit IO1 sends the received control information to the actuator site AC1. The actuator suite AC1 operates, based on the received control information. Alternatively, if the input-output control circuit IO1 has the capability of control task processing in addition to normal input-output control, it may process a control task that does not require the aid of the control circuit CPU1. In this case, the input-output control circuit IO1 executes the control task, based on sensor information received from the sensor suite SN1, and sends generated actuate control information to the actuator suite AC1. The actuator suite AC1 operates, based on the received control information.

Conventionally, all of such a great number of tasks need to be processed by the electronic control unit ECU1 and the electronic control unit ECU1 is provided with the capability required for the processing. In Embodiment 9, if the electronic control unit ECU1 cannot process all control tasks, the input-output control circuit IO1 sends sensor information received from the sensor suite SN1 to any other electronic control unit ECU2, ECU3, ECU4, or the control circuit CPU4 via the network NW1. The receiving unit or circuit generates actuator control information, based on the sensor information, and sends the control information to the input-output control circuit IO1 via the network NW1. The input-output control circuit IO1 sends the received control information to the actuator suite AC1. The actuator suite AC1 operates, based on the received control information.

The electronic control units ECU2 and ECU3 also operate in the same way as for the electronic control unit ECU1. On the other hand, in the electronic control unit ECU4, the input-output control circuit IO4 executes a control task, based on sensor information received from the sensor suite SN4, and sends generated actuator control information to the actuator suite AC4. The actuator suite AC4 operates, based on the received control information. If the input-output control circuit IO4 is lacking in the control task processing capability or the capability is insufficient, it uses any other electronic control unit ECU1, ECU2, ECU3, ECU4, or the control circuit CPU4 via the network NW1 to have a control task processed by the unit or circuit, in the same manner as for other electronic control units ECU1, ECU2, and ECU3.

In the case where the electronic control unit ECU1 cannot process all control tasks, the ECU1 must determine what control task to be allocated to any other electronic control unit ECU2, ECU3, ECU4, or the control circuit CPU4 via the network NW1. Generally, the control circuit assigns priorities to control tasks and processes the tasks in order of highest to lowest priorities. If two or more tasks have the same priority, a task earliest received is first processed. Thus, high-priority tasks can be processed by the control circuit CPU1 within its processing capacity limit and the remaining low-priority tasks can be allocated to other electronic control units ECU2, ECU3, ECU4, or the control circuit CPU4; in this way, control tasks can be allocated. Response time of a control task from receiving sensor information until completion of the control task is limited to control the actuator suite at appropriate timing. This response time limit varies from one control task to another. Communicating information via the network takes longer than transmission by a direct signal line. Therefore, according to the response time limits, control tasks for which the time to complete is coming earlier should be processed by the control circuit CPU1 and the remaining tasks for which the time to complete is relatively late allocated to other electronic control units ECU2, ECU3, ECU4, or the control circuit CPU4; this manner facilitates compliance with the response time limits. Based on this concept, by applying the load sharing method of Embodiments 1 to 9, load sharing with ensured performance of real-time processing can be implemented.

In Embodiment 9, a communication packet for requesting another control unit for task execution according to the packet example shown in FIG. 8 can be used. However, because the input-output control circuits are connected to the network, a method can be taken in which the control unit that executes a task accesses the input signal from the sensor via the network without input data transmission in the request packet for task run. If it is important to reduce the network load, tasks that make the network load heavier than the processing load of the control circuit, e.g., tasks requiring data to be transferred greater than the amount of computation within the control circuit should be processed by the control circuit CPU1 and the remaining tasks requiring a relatively small amount of data to be transferred should be allocated to other electronic control units ECU2, ECU3, ECU4, or the control circuit CPU4; in this way, the network load involved in load sharing can be reduced. The data amount to be transferred per task can be obtained from the information in the task management list shown in FIG. 6 and used for the description of Embodiment 5.

For control units for motor vehicles or the like, control tasks to be processed are determined before the units are productized. However, timing at which each control task is executed and the processing load per task changes, according to circumstances. Therefore, optimization is carried out before productizing to prevent a control burst under all possible conditions. It is thus possible to determine optimum load sharing rules in advance, according to situations. Alternatively, general-purpose load sharing rules independent of products may be created and incorporated into an OS or implemented in middleware; this eliminates the need of manual optimization of load sharing in the optimization before productizing. As a result, system designers can write a control program without caring that a control task is executed by which control circuit. After productizing, there is a possibility of system configuration change for function enhancement or because of part failure. With the capability of automatic optimization of load sharing rules adaptive to system reconfiguration, optimum load sharing can be maintained. Because a great number of control tasks change, according to circumstances, by appropriately applying on-demand load sharing by load sharing rules and automatic optimization of load sharing rules adaptive to circumstantial change, more optimum load sharing can be achieved.

Next, fault tolerance of Embodiment 9 is described. In Embodiment 9, since the actuator suite AC1, sensor suite SN1, and input-output control circuit IO1 are essential for tasks for controlling the actuator suite AC1, in case they break down so as to affect control task processing, it becomes impossible to execute the tasks for controlling the actuator suite AC1. Therefore, measures for enhancing fault tolerance at the component level such as duplication are taken for these components, according to the fault tolerance requirement level. If the input-output control circuit IO1 is incapable of processing a control task, normally, the direct signal line DC1 and control circuit CPU1 are still used. In case of the direct signal line DC1 fault, processing can be continued by connecting the input-output control circuit IO1 and control circuit CPU1 via the network NW1. Alternatively, in case of the direct signal line DC1 fault or control circuit CPU1 fault, control can be continued by having control tasks executed on other electronic control units ECU2, ECU3, ECU4, or the control circuit CPU4 via the network NW1 in Embodiment 9, in the same way as in the foregoing case where the electronic control unit ECU1 cannot process all control tasks.

At this time, the load of the network NW1 and the load of the electronic control units ECU2, ECU3, ECU4 or the control circuit CPU4 increase. However, in a system where a great number of electronic control units are connected, a relative load increase can be suppressed within the permissible extent. By provision of an allowance for the whole system capacity, the same processing as before the fault can be continued. For example, if one control circuit fault results in a 10% decrease in the capacity, the capacity should be preset 10% higher. Even if the capacity allowance is cut to a minimum with priority given to efficiency, the processing load in case of the fault can be decreased by lowering degradation-tolerable facilities in an emergency in terms of comfort, mileage, cleaning exhaust gas, etc. and processing can be continued. For control systems for motor vehicles or the like, the reliability of components is sufficiently high and it is generally considered unnecessary to suppose that two ore more components fail at the same time. For example, the probability that two components which may fail once for one hundred thousand hours both fail within one hour is once for ten billion hours.

In conventional systems, the control circuit CPU1 and input-output control circuit IO1 are united or they are separate, but the input-output control circuit IO1 is connected to the network NW1 via the control circuit CPU1, and multiplexing including the direct signal line DC1 and control circuit CPU1 is required to improve fault tolerance. Likewise, fault tolerance can be achieved in other electronic control units ECU2, ECU3. The electronic control unit ECU4 consists entirely of the actuator suite AC4, sensor suite SN4, and input-output control circuit IO4 which require fault tolerance and, therefore, measures for enhancing fault tolerance such as duplication must be taken.

In Embodiment 9, the network NW1 is not multiplexed. In the event of the network NW1 failure, each electronic control unit ECU1 to ECU4 must execute control tasks without relying on load sharing via the network NW1. If a system is run such that load sharing via the network NW1 is not performed during normal operation and, in case of a fault, processing is continued by load sharing via the network NW1, the system can deal with faults other than a multi-fault with an extremely low probability like the fault in which the network NW1 and an electronic control unit fail simultaneously. If the capacity allowance is cut to a minimum with priority given to efficiency, in case of a fault, the processing load can be decreased by lowering degradation-tolerable facilities in an emergency and processing can be continued, so that tasks can be executed with lower performance for reliance on load sharing via the network NW1.

With the advancement of control systems, high performance and high functionality of the control circuits CPU1 to CPU4 are required. Capability to accomplish fault tolerance without multiplexing these CPUs and the direct signal lines DC1 to DC4 and the network NW1 for connecting the CPUs greatly contributes to system efficiency enhancement.

In Embodiment 9, control of load sharing of tasks for controlling the actuator suite AC1 is performed by the control circuit CPU1 or input-output control circuit IO1 during normal operation. Since the input-output control circuit IO1 requires duplication or the like for improving fault tolerance, it is desirable to make this circuit as small as possible with a limited capacity. If the load sharing control is performed by the control circuit CPU1, this contributes downsizing of the input-output control circuit IO1. In this case, load sharing in case of the control circuit CPU1 fault must be performed by any other electronic control unit ECU2 to ECU4. Therefore, the input-output control circuit IO1 should be provided with a capability to detect the control circuit CPU1 fault. In case the control circuit CPU fault occurs, the input-output control circuit IO1 sends a task control process request to any other electronic control unit ECU2 to ECU4, selected by predetermined rules. The electronic control unit that received the request adds the control task process to the control tasks that it manages. This transfer of the load sharing control may be performed in a way that the control is entirely transferred to one of other electronic control units ECU2 to ECU4 or in a way that the control load is distributed to other units. It is desirable that the control is transferred to a control circuit that will first execute a control task, according to load sharing rules. Otherwise, if the load sharing control is performed by the input-output control circuit IO1, the size of the input-output control circuit IO1 increases, but it is unnecessary to transfer the load sharing control to any other electronic control unit ECU2 to ECU4 in case of the control circuit CPU1 fault.

### Embodiment 10

FIG. 12 shows an example of a modification to the system configuration of FIG. 11 including duplicated networks. In the configuration of FIG. 11, processing cannot be continued if the network fault occurs when a plurality of electronic control units operate together by communicating information via the network. Consequently, it is needed to decrease the quality of control to a level that cooperative control is not required in case of the network fault. With provision of duplicated network connections by adding a second network NW2 as shown in FIG. 12, even if one network fails, processing via the other network can be continued. However, straightforward duplication improves the fault tolerance, but decreases the efficiency due to hardware volume increase.

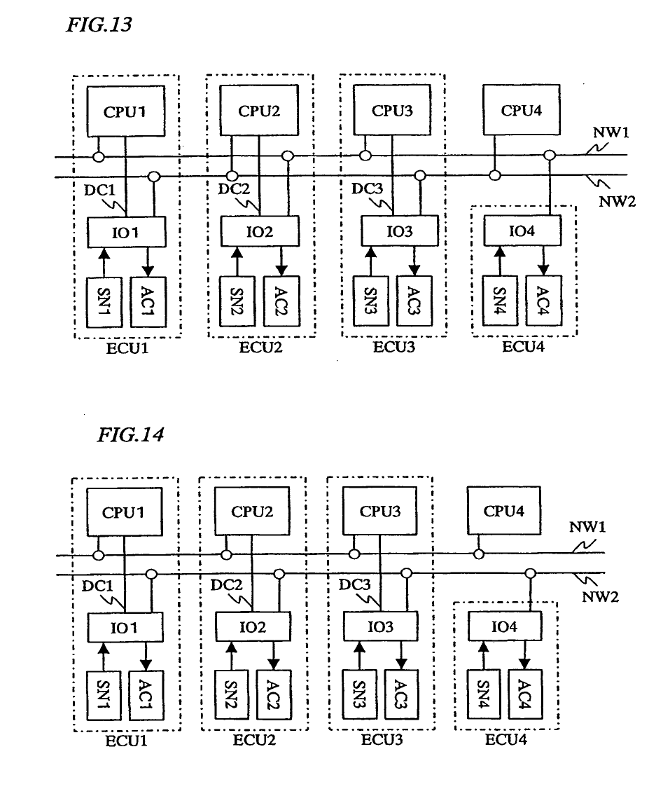

FIG. 13 shows an example of a modification to Embodiment 10, where the system network in FIG. 11 is separated. As compared with the networks in the configuration of FIG. 12, duplicated networks are provided, based on the same concept as FIG. 12, but networks NW1 and NW2 are separate. To the network NW1, the control circuits CPU1 and CPU3 and the input-output control circuits IO2 and IO4 are connected. To the network NW2, the control circuits CPU2 and CPU4 and the input-output control circuits IO1 and IO3 are connected. In the configuration of FIG. 12, because the networks are symmetric, no restriction is placed on load sharing via the networks. In FIG. 13, when the electronic control unit ECU1 performs load sharing, it is desirable to allocate loads to the CPU2 and CPU4 to which connection is made from the input-output control circuit IO1 via the network NW2. However, connection from the input-output control circuit IO1 to the CPU3 is made via the direct signal line DC1, control circuit CPU1, and network NW1 or via the network NW2, input-output control circuit IO3, and direct signal line DC3, and it is therefore possible to allocate a load to the control circuit CPU3. If the input-output control circuits IO2 to IO4 have the capability to process control tasks in addition to normal input-output control and loads of the electronic control unit ECU1 can be allocated to them, information communication with the input-output control circuit IO3 can be performed via the network NW2 and communication with the input-output control circuits IO2 and IO4 via paths similar to the path to the control circuit CPU3.

In case of the direct signal line DC1 fault or control circuit CPU1 fault, the paths via the DC1 line and the CPU1 are disabled, but backing up of the control circuit CPU1 can be performed, through other paths, by the control circuits CPU2 to CPU4 or the input-output control circuits IO2 to IO4. In case of the network NW2 fault, the input-output control circuit IO1 can be connected to the network NW1 via the direct signal line DC1 and the control circuit CPU1. Conversely, in case of the network NW1 fault, the control circuit CPU1 can be connected to the network NW2 via the direct signal line DC1 and the input-output control circuit IO1. Since a bypass via the direct signal line DC1 is simpler and faster than a bypass via the plural networks, it is sufficient as a backup circuit in case of failure. For other electronic control units ECU2 to ECU4, load sharing and backup can be accomplished in the same way as above.

### Embodiment 11

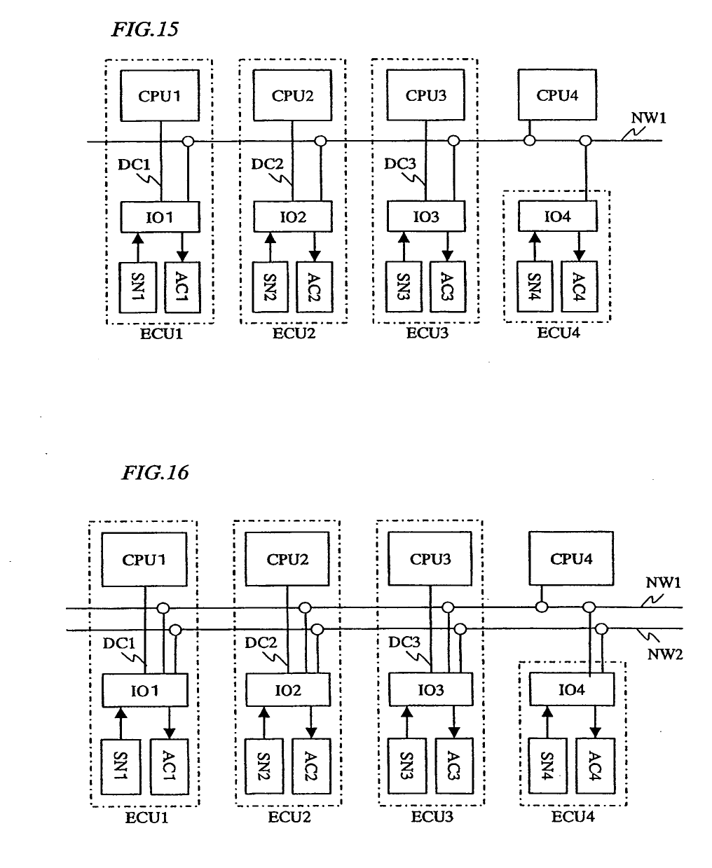

FIG. 14 shows an embodiment wherein the system network in FIG. 11 is separated in a different manner from the networks in FIG. 13. The networks NW1 and NW2 are separated. To the network NW1, control circuits CPU1 to CPU4 are connected. To the network NW2, the input-output control circuits IO1 to IO4 are connected. In Embodiment 11, if loads of the electronic control unit ECU1 are allocated to the control circuits CPU2 to CPU4, connections to these CPUs are made from the input-output control circuit IO1 via the direct signal line DC1, control circuit CPU1, and network NW1 or the network NW2, input-output control circuits IO2 to IO4, and direct signal lines DC2 to DC4. If the loads are allocated to the input-output control circuits IO2 to IO4, connections thereto are made via the network NW2. In case of the direct signal line DC1 fault or control circuit CPU1 fault, the paths via the DC1 line and the CPU1 are disabled, but backing up can be performed, through other paths, by the control circuits CPU2 to CPU4 or the input-output control circuits IO2 to IO4. For other electronic control units ECU2 to ECU4, load sharing and backup can be accomplished in the same way as above.

### Embodiment 12

FIG. 15 shows an embodiment wherein the network connections in the system of FIG. 11 are reduced. In the configuration of FIG. 15, the connections to the network NW1 of the control circuits CPU1 to CPU3 are removed. Operation without using the network NW1 is the same as described for the system of FIG. 11. When the control circuits CPU1 to CPU3 are used via the network NW1, the control circuits CPU1 to CPU3 are connected to the network NW1 via the input-output control circuits IO1 to IO3 and the direct signal lines DC1 to DC3, instead of direct connections to the network NW1 as provided in the system of FIG. 11. As compared with the system of FIG. 11, in case any direct signal line DC1 to DC3 fails, it is impossible to use the corresponding control circuit CPU1 to CPU3, but there is no problem if allowance is provided just in case any control circuit CPU1 to CPU3 fails. If allowance is cut to a minimum with priority given to efficiency, there is a rise in the probability that the quality of control must decrease for the probability that any direct signal line DC1 to DC3 fails. However, because efficiency increases for the reduction in the network connections, this embodiment is suitable for a system in which priority is given to efficiency.

### Embodiment 13

FIG. 16 shows an embodiment wherein the system network in FIG. 15 is duplicated. In this configuration, the network connections are duplicated by adding a second network NW2. Even if one network fails, the other network can be used and, therefore, processing via the network can be continued. The input-output control circuits IO1 to IO4 are directly connected to the networks NW1 and NW2 without using the path via the direct signal line DC1 and control circuit CPU1, fault tolerance can be accomplished without multiplexing the direct signal line DC1 and control circuit CPU1.

### Embodiment 14

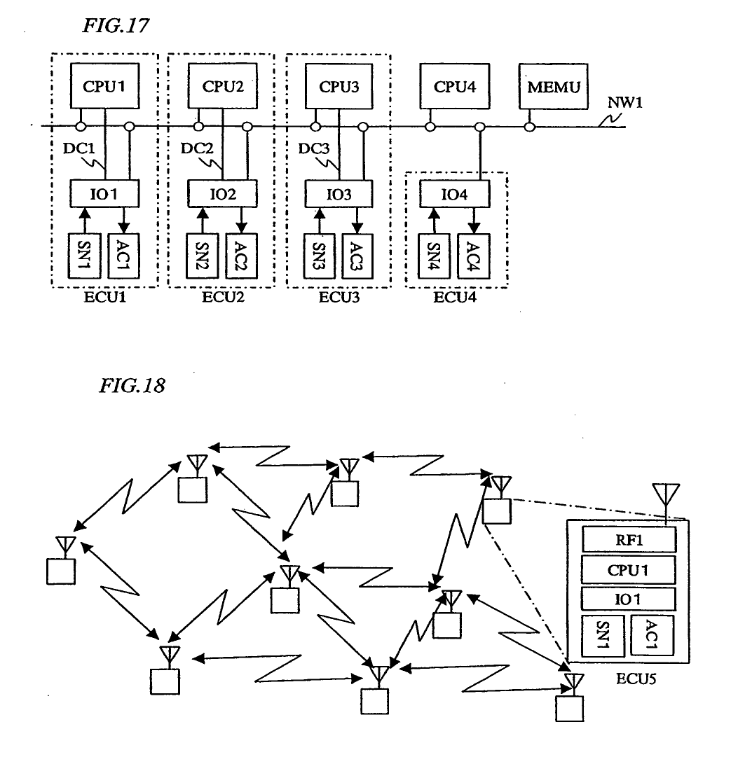

FIG. 17 shows an example of a modification to the Embodiment 9 control system configuration of FIG. 11 employing both direct signal lines and a network, wherein a storage unit MEMU mentioned in Embodiment 8 is connected to the network NW1. In this storage unit MEMU, a database to which all the control units ECU commonly get access and store their load status periodically at predetermined intervals is set up, so that each control unit ECU can access this database and obtain other ECUs' load status information by which it can determine what ECU to which task processing can be requested. Obviously, this storage unit MEMU can be attached to either of the networks NW1 and NW2 in Embodiments 10 to 13.

### Embodiment 15

The physical wiring of the networks in the foregoing embodiments can be constructed with transmission lines through which electrical signals are transmitted or optical transmission lines. Moreover, a wireless network can be constructed.

FIG. 18 shows a wireless network configuration example. A wireless data communication node like a control unit ECU5 shown in FIG. 18 includes a radio communication module RF1 and an antenna in addition to the control circuit CPU1, input-output control circuit IO1, sensor suite SN1, and actuator suite AC1. In the network where a plurality of control nodes configured as above wirelessly communicate with each other and communication between far distant nodes is relayed through an intermediate node or nodes, the load sharing method of Embodiments 1 to 9 can also be applied. However, in this case, the number of transit nodes for communication differs, depending on the control unit to which task execution is requested. Thus, communication latency must be changed. For each peer of nodes, communication latency by the number of hops between the nodes is obtained in advance or when the network is built and used in determining whether real-time processing can be ensured.

### Embodiment 16

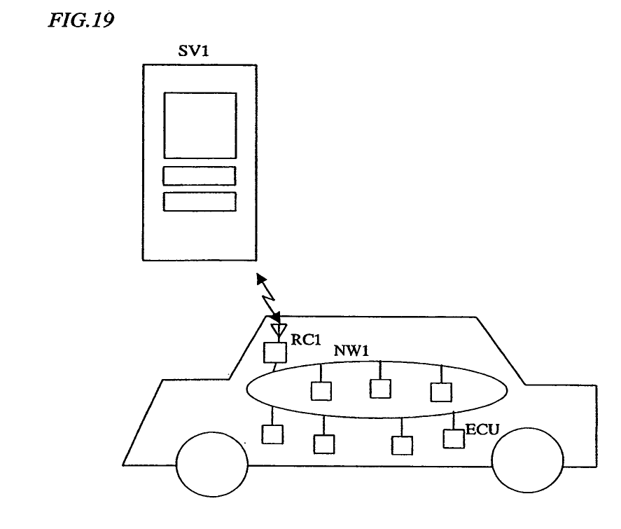

FIG. 19 shows an example of a network comprising control units connected via an in-vehicle LAN and a server external to the vehicle, the server being wirelessly connected to the LAN. To the in-vehicle network NW1 shown in FIG. 19, a plurality of control units are connected in the same way as in the foregoing embodiments. A control unit RC1 having a wireless communication function wirelessly communicates with the server SV1 external to the vehicle. The server SV1 is installed, for example, on the side of a road in the case of short-range wireless communication with the vehicle. Alternatively, the server is installed in a base station when a long-range communication is applied. The server has a huge-capacity storage device and faster processing performance than the control units mounted in the vehicle. In this case also, by applying the load sharing method of Embodiments 1 to 9, for a task for which the computing throughput is regarded as important, that is, provided that the computer processing load is large, the merit of the server throughput much greater than an in-vehicle control unit exceeds the overhead by communication latency, and the required deadline can be complied with, the server is requested to execute the task. Thereby, advanced information processing requiring complicated computing, which have heretofore been impossible by an in-vehicle system can be achieved. Even if in-vehicle computing resources are not sufficient, system enhancement can be accomplished by using the computing resources external to the vehicle without replacing and enhancing the in-vehicle control units and arithmetic processing units.

According to the present invention, ensured performance of real-time processing, improved fault tolerance, or virtualizing a plurality of control circuits can be accomplished.

This invention relates to a distributed control system where a plurality of control units which execute a program for controlling a plurality of devices to be controlled are connected via a network and accomplishes distributed control to reduce system costs and improve fault tolerance, while ensuring the performance of real-time processing in applications strictly requiring real-time processing such as motor vehicle control, robot control, and controlling manufacturing equipment at factories.

What is claimed is:

1. A distributed control system comprising:
a plurality of control units connected by a network and executing a plurality of tasks in a distributed manner,
wherein each of the plurality of control units having a task management list for tasks requested to run as the tasks to be executed by itself,
wherein each of the tasks includes information of a deadline or task run cycle period as time required until task completion, and
wherein each of the plurality of control units determines whether all tasks listed in said task management list can be completed in compliance with said deadline or task cycle period, if not as determined, selects a task that can be executed by another control unit in compliance with said deadline or task cycle period from among the tasks listed in said task management list, and requests another control unit to execute the task.

2. The distributed control system according to claim 1,
wherein each of said tasks includes a task processing time and a communication latency time which indicates sending and returning time when the task is requested of and executed by another control unit, wherein tasks for which the sum of said task processing time and said communication latency time is greater than said deadline or task cycle period are executed on the control unit where said tasks were invoked, and,
wherein one of tasks, for which the sum of said task processing time and said communication latency is smaller than said deadline or task cycle period, is selected and requested of and executed by another control unit connected via the network.

3. The distributed control system according to claim 2,
wherein the amount of data to be accessed within storage and the amount of input data to be accessed are added to said task and said each of said plurality of control units includes means for calculating communication latency time, based on said amount of data.

4. The distributed control system according to claim 2,
wherein each of said plurality of control units includes means for observing network traffic and means for modifying communication latency time according to the traffic.

5. The distributed control system according to claim 2,
wherein if the control units have different task processing throughputs such as their computing capacity and storage configuration, said each control unit includes means for modifying task processing time according to task processing throughput.

6. The distributed control system according to claim 2,
wherein said each of plurality of control units updates said task processing time and said communication latency time by task run time statistics.

7. The distributed control system according to claim 2,
wherein each of plurality of said control units stores tasks waiting for being executed in the task management list, refers to said task management list when a request to run a new task occurs, checks whether said new task can be completed within its deadline, if execution within the deadline is impossible, selects at least one task that should be requested of and executed by another control unit from among the tasks listed in the task management list and the new task to run, and sends a request command to run the selected task to another control unit via the network.

8. The distributed control system according to claim 7,
wherein when sending said request command to run the task, said each of plurality of control units sends the task's deadline and processing time information together.

9. The distributed control system according to claim 7,
wherein before sending said request command to run the task, said each of plurality of control units sends said task's deadline, processing time, and communication latency time to at least one of other control units, thereby inquiring whether the task can be completed within said deadline, and selects a control unit to which to send the request command to run the task actually from among other control units from which said each control unit received an acceptance return.

10. The distributed control system according to claim 7,
wherein before sending said request command to run the task, said each of plurality of control units inquires of at least one of other control units about load status until said task's deadline time, checks whether the task can be completed by another control unit within said deadline from said task's deadline, processing time, and communication latency time and the load status returned, and selects a control unit to which to send the request command to run the task actually from among other control units on which the task can be executed as the result of the check.

11. The distributed control system according to claim 1,
wherein said network is constructed with optical transmission lines, electrical transmission line, or wireless channels.

12. A distributed control system comprising:
a first control circuit having a first sensor;
second and third control circuits which process first information from said first sensor;
a first dedicated path connecting the first and second control circuits; and
a second path connecting the first and third control circuits,
wherein said first information may be transferred to the second control circuit via the first path or transferred to the third control circuit via the second path.

13. The distributed control system according to claim 12,
wherein said second path is a network type path to which three or more circuits connect.

14. The distributed control system according to claim 12,
wherein said second path is an indirect path via a fourth control circuit.

15. The distributed control system according to claim 12, further comprising:
a third path connecting said first control circuit and said third control circuit,
wherein even if either the third path or said second path fails, the connection between said first control circuit and said third control circuit is maintained.

16. The distributed control system according to claim 12,
wherein when said first information cannot be processed properly by said second circuit, the first information is processed by said third control circuit.

17. A distributed control system comprising
a plurality of first control units, each including a sensor, a first control circuit connected to said sensor, a second control circuit which processes information from said sensor, an actuator which responds to a signal from said first control circuit, and a dedicated path connecting said first control circuit and said second control circuit, and
a network linking said plurality of control units,
wherein said first control circuit and said second control circuit of each of the plurality of first control units are connected to said network.

18. The distributed control system according to claim 17, further comprising:
a second control unit comprising a second sensor, a third control circuit connected to said second sensor, and a second actuator which responds to a signal from said third control circuit, and
a fourth control circuit which processes information from any control unit.

19. The distributed control system according to claim 17, further comprising:
a storage unit which is accessible from the plurality of control units, stores information from the plurality of control units, and provides stored information.
